(19) United States
(12) Patent Application Publication
(10) Pub. No.: US 2020/0009555 A1
(43) Pub. Date: Jan. 9, 2020

(54) CARTRIDGE FOR TESTING A SAMPLE AND METHOD FOR PRODUCING A CARTRIDGE OF THIS KIND

(71) Applicant: BOEHRINGER INGELHEIM VETMEDICA GMBH, Ingelheim am Rhein (DE)

(72) Inventors: Hannah SCHMOLKE, Didderse (DE); Matthias KRONSBEIN, Kaiserslautern (DE); Lutz WEBER, Zweibruecken (DE)

(73) Assignee: BOEHRINGER INGELHEIM VETMEDICA GMBH, Ingelheim am Rhein (DE)

(21) Appl. No.: 16/337,979

(22) PCT Filed: Oct. 5, 2017
(86) PCT No.: PCT/EP2017/025284

§ 371 Date: Mar. 29, 2019

(30) Foreign Application Priority Data
Oct. 7, 2016 (EP) 16020376.6

(51) Int. Cl. B01L 3/00

(52) U.S. Cl. CPC B01L 3/502707; B01L 2200/0689; B01L 2200/10; B01L 2200/12; B01L 2400/0655; B01L 2300/044; B01L 2300/048; B01L 2300/0645; B01L 2300/0816; B01L 2200/16

(57) ABSTRACT

A cartridge for testing a sample, in particular, a biological sample, and a method for the production of such a cartridge are provided, the cartridge comprising a main body having a plurality of channels and cavities that are covered by a cover or a film. For the purpose of simple production, liquid reagents are introduced into corresponding storage cavities through the main body, with the storage cavities being optionally (additionally) covered by aluminium film. Furthermore, a conditioned atmosphere is preferably introduced into a closed fluid system in the cartridge containing dry reagents and/or a sensor apparatus.

### BACKGROUND OF THE INVENTION

### Field of the Invention

The present invention relates to a cartridge for testing a sample, and a method for producing such a cartridge, the cartridge including one or more storage cavities which are each individually fluidically closed by the cover and/or valves of the cartridge, each of which storage cavities contains a liquid reagent and comprises a corresponding opening in the main body for introducing the respective reagent, the openings being closed after introducing the respective reagents, and/or the cartridge including a main body having a plurality of channels and cavities, and a cover for the channels and cavities, wherein the channels and cavities form a fluid system that is fluidically closed to the outside in a delivery state of the cartridge.

Preferably, the present invention deals with analyzing and testing a sample, in particular from a human or animal, particularly preferably for analytics and diagnostics, for example with regard to the presence of diseases and/or pathogens and/or for determining blood counts, antibodies, hormones, steroids or the like. Therefore, the present invention is in particular within the field of bioanalytics. A food sample, environmental sample or another sample may optionally also be tested, in particular for environmental analytics or food safety and/or for detecting other substances.

Preferably, at least one analyte (target analyte) of a sample can be determined, identified or detected by means of the cartridge. In particular, the sample can be tested for qualitatively or quantitatively determining at least one analyte, for example in order for it to be possible to detect or identify a disease and/or pathogen.

Within the meaning of the present invention, analytes are in particular nucleic-acid sequences, in particular DNA sequences and/or RNA sequences, or proteins, in particular antigens and/or antibodies. In particular, by means of the present invention, nucleic-acid sequences can be determined, identified or detected as analytes of a sample, or proteins can be determined, identified or detected as analytes of the sample. More particularly preferably, the present invention deals with systems, devices and other apparatuses for carrying out a nucleic-acid assay for detecting or identifying a nucleic-acid sequence or a protein assay for detecting or identifying a protein.

The present invention deals in particular with what are known as point-of-care systems, i.e. in particular with mobile systems, devices and other apparatuses, and deals with methods for carrying out tests on a sample at the sampling site and/or independently and/or away from a central laboratory or the like. Preferably, point-of-care systems can be operated autonomously and/or independently of a mains network for supplying electrical power.

### Description of the Related Art

U.S. Pat. No. 5,096,669 A discloses a point-of-care system for testing a biological sample, in particular a blood sample. The system comprises a single-use cartridge and an analysis device. Once the sample has been received, the cartridge is inserted into the analysis device in order to carry out the test. The cartridge comprises a microfluidic system and a sensor apparatus comprising electrodes, which apparatus is calibrated by means of a calibration liquid and is then used to test the sample.

Furthermore, International Publication No. WO 2006/125767 A1, and corresponding U.S. Pat. No. 9,110,044 B2, disclose a point-of-care system for integrated and automated DNA or protein analysis, comprising a single-use cartridge and an analysis device for fully automatically processing and evaluating molecular-diagnostic analyses using the single-use cartridge. The cartridge is designed to receive a sample, in particular blood, and in particular allows cell disruption, PCR and detection of PCR amplification products, which are bonded to capture molecules and provided with a label enzyme, in order for it to be possible to detect bonded PCR amplification products or nucleic-acid sequences as target analytes in what is known as a redox cycling process.

International Publication No. WO 2015/001070 A1, and corresponding US Patent Application Publication No. 2016/0167047 A1, disclose a microfluidic flow cell into which a carrier element containing a dry reagent is inserted so that the dry reagent can be dissolved in a liquid in an associated cavity in the flow cell.

International Publication No. WO 2006/056787 A1, and corresponding US Patent Application Publication 2008/0248590 A1, disclose a lab-on-a-chip device for detecting molecules in a fluid sample. The device has one or more elongated, winding channels which contain different sections filled with reagents, wash buffers or the like. These section are spaced apart from each other and separated only by air or other fluid.

International Publication No. WO 2004/076056 A2, and corresponding US Patent Application Publication No. 2005/0129580 A1, disclose a microfluidic chemical reactor for the production of nanoparticles. A growth section is formed by an elongated winding channel comprising one or more inlets and outlets. An inert atmosphere may be maintained in the channel.

### SUMMARY OF THE INVENTION

The problem addressed by the present invention is to provide a cartridge for testing a sample, and a method for producing a cartridge of this kind, simple and cost-effective production of the cartridge being made possible and facilitated, the cartridge in particular containing a plurality of reagents or all the reagents required for testing the sample.

The above problem is solved by a cartridge for testing a sample, the cartridge including a main body having a plurality of channels and cavities and a cover for the channels and cavities, the cartridge further comprising one or more storage cavities which are each individually fluidically closed by the cover and/or valves of the cartridge, each of which storage cavities contains a liquid reagent and comprises a corresponding opening in the main body for introducing the respective reagent, the openings being closed after introducing the respective reagents, and/or the cartridge including a main body having a plurality of channels and cavities, and a cover for the channels and cavities, wherein the channels and cavities form a fluid system that is fluidically closed to the outside in a delivery state of the cartridge. The above problem is also solved by a method for producing such a cartridge for testing a sample, including the steps of applying cover to a front of the main body of the cartridge, the main body including a plurality of channels and cavities, the cover operating to close the channels and cavities in a delivery state, and at least one of the steps of filling and otherwise already closed cavity with liquid reagent through an opening in a back of the main body, and subsequently closing the opening, and/or forming a fluid system that is fluidically closed to the outside in the delivery state by the plurality of channels and cavities, the fluid system containing one or more dry reagents or a sensor apparatus for chemically bonding at least one analyte of the sample, a conditioned atmosphere being introduced into the fluid system from the back through the main body, the conditioned atmosphere being conditioned with regard to at least one of composition, humidity and/or pressure.

One aspect of the present invention is that the cartridge preferably comprises one or more storage cavities which are each individually fluidically closed by the cover and/or valves of the cartridge in the delivery state, and into each of which cavities a liquid reagent is introduced through the main body. This allows simple, automated production, in particular because substantial prefabrication can initially be carried out, and liquid reagents can be introduced only shortly before the cartridge is completed.

Particularly preferably, the liquid reagent is introduced into the respective storage cavities through the base of the respective storage cavities and/or through an opening in the main body, said storage cavities otherwise already being closed, and the opening is subsequently closed, in particular in a gas-tight and/or permanent manner. This is conducive to simple and rapid and/or defined production and filling.

Each opening preferably comprises an integrated vent, and therefore when the liquid reagent is introduced, gas contained in the respective storage cavities can escape directly through the opening.

According to another aspect of the present invention, which can also be implemented independently, a fluid system that is fluidically closed to the outside and contains one or more dry reagents is formed by a plurality of channels and cavities of the cartridge, and a conditioned atmosphere is introduced into the fluid system. This is conducive to simple production, it being possible in particular to also achieve optimised storage stability of the finished or delivered cartridge.

The fluid system preferably contains at least one dry reagent that is received in particular in a cavity, and/or a sensor apparatus for chemically bonding at least one analyte of the sample to be tested. The dry reagent and/or the sensor apparatus is also exposed to the conditioned atmosphere on account of being integrated in and/or connected to the fluid system. This is conducive to optimised storage stability. Furthermore, simple production is possible since the desired conditioned atmosphere can be simultaneously applied also to different components and parts, such as dry reagents as well as the sensor apparatus, by means of a conditioned atmosphere being introduced just once through an opening.

The atmosphere is preferably introduced into the fluid system through an opening in the main body and/or in the base of a cavity, such as a collection cavity, and this opening is subsequently closed in a gas-tight and/or irreversible manner. In this way, an optimal atmosphere, in particular also for different dry reagents, can be achieved in different cavities on the cartridge in a simple manner.

Particularly preferably, the fluid system that is in particular open only via the opening is first evacuated, it being possible for this to be carried out very simply by evacuating the surroundings of the cartridge, before the conditioned atmosphere is introduced.

Depending on the application and requirements, the “conditioned atmosphere” can in particular be any desired gas or gas mixture having any desired pressure, preferably normal pressure, but optionally also negative pressure, and/or in particular having a specific atmospheric humidity.

Particularly preferably, dry reagents are introduced into the fluid system and/or are introduced in addition to liquid reagents. This is achieved in particular by inserting carrier elements, provided with the respective dry reagents, into the main body, as is described in particular in International Publication No. WO 2015/001070 A1.

According to another aspect of the present invention, which can also be implemented independently, the cover of the main body of the cartridge, which is in principle preferably formed by a plastics film, is made of an inorganic material, in particular metal, particularly preferably aluminium, at least in the region of a storage cavity. In particular, an additional cover made of this material, preferably a piece of film sheet made of this material, and is in addition adhered or adhesively bonded to the cover in the region of the respective storage cavities. This makes simple production possible, it being possible for improved storage stability to be achieved in a simple manner by reducing undesired diffusion.

The term “cartridge” is preferably understood to mean a structural apparatus or unit designed to receive, to store, to physically, chemically and/or biologically treat and/or prepare and/or to measure a sample, preferably in order to make it possible to detect, identify or determine at least one analyte, in particular a protein and/or a nucleic-acid sequence, of the sample.

A cartridge within the meaning of the present invention preferably comprises a fluid system having a plurality of channels, cavities and/or valves for controlling the flow through the channels and/or cavities.

In particular, within the meaning of the present invention, a cartridge is designed to be at least substantially planar, flat and/or card-like, in particular is designed as a (micro)fluidic card and/or is designed as a main body or container that can preferably be closed and/or said cartridge can be inserted and/or plugged into a proposed analysis device when it contains the sample.

The above-mentioned aspects and features of the present invention and the aspects and features of the present invention that will become apparent from the claims and the following description can in principle be implemented independently from one another, but also in any combination or order.

Other aspects, advantages, features and properties of the present invention will become apparent from the claims and the following description of a preferred embodiment with reference to the accompanying drawings.

### BRIEF DESCRIPTION OF THE DRAWINGS

FIG. 1 is a schematic view of an analysis device and a proposed cartridge received in the analysis device;

FIG. 2 is a schematic view of the cartridge;

FIG. 3 is a schematic perspective front view of the cartridge;

FIG. 4 is a schematic perspective rear view of the cartridge comprising a receiving cavity;

FIG. 5 is a schematic plan view of a connection of the receiving cavity or an opening of a storage cavity; and

FIG. 6 is a schematic sectional detail of the cartridge while it is being filled with a sample.

### DETAILED DESCRIPTION OF THE INVENTION

In the Figures, which are only schematic and sometimes not to scale, the same reference signs are used for the same or similar parts and components, corresponding or comparable properties and advantages being achieved even if these are not repeatedly described.

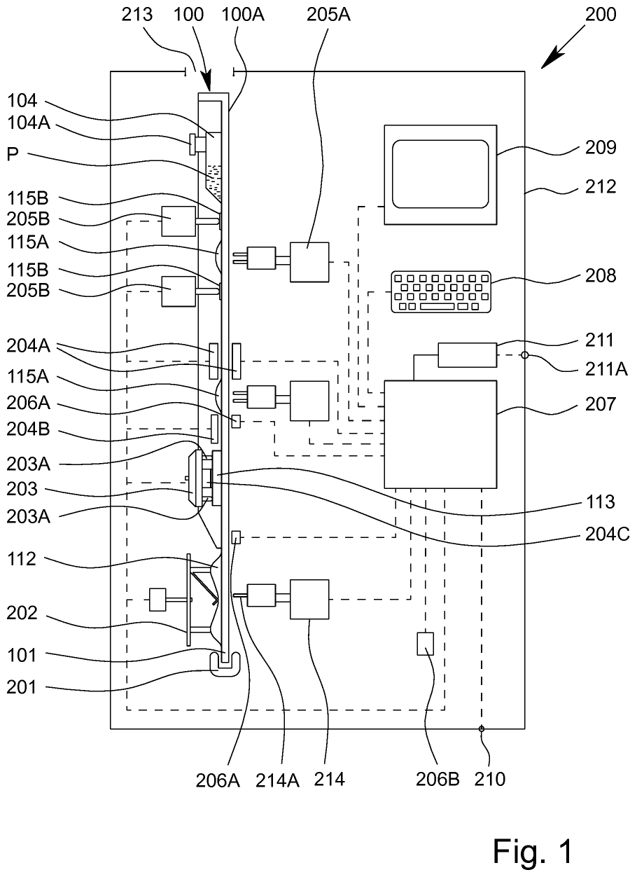

FIG. 1 is a highly schematic view of a proposed apparatus or cartridge 100 in an analysis device 200 for testing an in particular biological sample P.

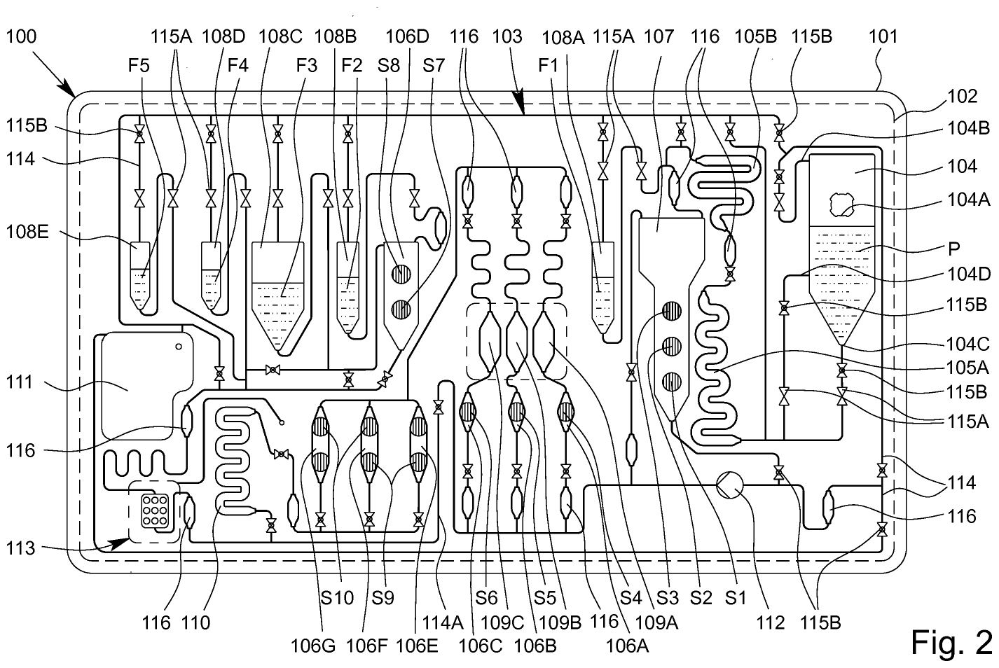

FIG. 2 is a schematic view of a preferred embodiment of the proposed apparatus or cartridge 100 for testing the sample P. The apparatus or cartridge 100 in particular forms a handheld unit, and in the following is merely referred to as a cartridge 100.

The term “sample” is preferably understood to mean the sample material to be tested, which is in particular taken from a human or animal. In particular, within the meaning of the present invention, a sample is a fluid, such as saliva, blood, urine or another liquid, preferably from a human or animal, or a component thereof. Within the meaning of the present invention, a sample may be pretreated or prepared if necessary, or may come directly from a human or animal or the like, for example. A food sample, environmental sample or another sample may optionally also be tested, in particular for environmental analytics, food safety and/or for detecting other substances, preferably natural substances, but also biological or chemical warfare agents, poisons or the like.

A sample within the meaning of the present invention preferably contains one or more analytes, it preferably being possible for the analytes to be identified or detected, in particular qualitatively and/or quantitatively determined. Particularly preferably, within the meaning of the present invention, a sample has target nucleic-acid sequences as the analytes, in particular target DNA sequences and/or target RNA sequences, and/or target proteins as the analytes, in particular target antigens and/or target antibodies. Particularly preferably, at least one disease and/or pathogen can be detected or identified in the sample P by qualitatively and/or quantitatively determining the analytes.

Preferably, the analysis device 200 controls the testing of the sample P in particular in or on the cartridge 100 and/or is used to evaluate the testing and/or to collect, to process and/or to store measured values from the test.

By means of the analysis device 200 and/or by means of the cartridge 100 and/or using the method for testing the sample P, an analyte of the sample P, or particularly preferably a plurality of analytes of the sample P, can preferably be determined, identified or detected. Said analytes are in particular detected and/or measured not only qualitatively, but particularly preferably also quantitatively.

Therefore, the sample P can in particular be tested for qualitatively or quantitatively determining at least one analyte, for example in order for it to be possible to detect or identify a disease and/or pathogen or to determine other values, which are important for diagnostics, for example.

The cartridge 100 is preferably at least substantially planar, flat, plate-shaped and/or card-like.

The cartridge 100 preferably comprises an in particular at least substantially planar, flat, plate-shaped and/or card-like main body or support 101, the main body or support 101 in particular being made of and/or injection-moulded from plastics material, particularly preferably polypropylene.

The cartridge 100 preferably comprises at least one film or cover 102 for covering the main body 101 and/or cavities and/or channels formed therein at least in part, in particular on the front 100A, and/or for forming valves or the like, as shown by dashed lines in FIG. 2.

The cartridge 100 and/or the main body 101 thereof, in particular together with the cover 102, preferably forms and/or comprises a fluidic system 103, referred to in the following as the fluid system 103.

The cartridge 100, the main body 101 and/or the fluid system 103 are preferably at least substantially vertically oriented in the operating position and/or during the test, in particular in the analysis device 200, as shown schematically in FIG. 1. In particular, the main plane or surface extension of the cartridge 100 thus extends at least substantially vertically in the operating position.

The cartridge 100 and/or the fluid system 103 preferably comprises a plurality of cavities, in particular at least one receiving cavity 104, at least one metering cavity 105, at least one intermediate cavity 106, at least one mixing cavity 107, at least one storage cavity 108, at least one reaction cavity 109, at least one intermediate temperature-control cavity 110 and/or at least one collection cavity 111, the cavities preferably being fluidically interconnected by a plurality of channels.

Within the meaning of the present invention, channels are preferably elongate forms for conducting a fluid in a main flow direction, the forms preferably being closed transversely, in particular perpendicularly, to the main flow direction and/or longitudinal extension, preferably on all sides.

In particular, the main body 101 comprises elongate notches, recesses, depressions or the like, which are closed at the sides by the cover 102 and form channels within the meaning of the present invention.

Within the meaning of the present invention, cavities or chambers are preferably formed by recesses, depressions or the like in the cartridge 100 or main body 101, which are closed or covered by the cover 102, in particular at the sides. The volume or space enclosed by each cavity is preferably fluidically linked, in particular to the fluid system 103, by means of the channels.

In particular, within the meaning of the present invention, a cavity comprises at least two openings for the inflow and/or outflow of fluids.

Within the meaning of the present invention, cavities preferably have a larger diameter and/or flow cross section than channels, preferably by at least a factor of 2, 3 or 4. In principle, however, cavities may in some cases also be elongate, in a similar manner to channels.

The fluid system 103 preferably comprises a plurality of branched channels and/or branches. In particular, several channels of the fluid system 103 run side by side and/or parallel to each other, at least in part and/or in sections. Preferably, one or more channels of the fluid system 103 split up into a plurality of channels and/or several channels of the fluid system 103 are (re-)connected to a single channel Particularly, the fluid system 103 is not formed by only a single and/or continuous channel.

The cartridge 100 and/or the fluid system 103 also preferably comprises at least one pump apparatus 112 and/or at least one sensor arrangement or sensor apparatus 113.

In the example shown, the cartridge 100 or the fluid system 103 preferably comprises two metering cavities 105A and 105B, a plurality of intermediate cavities 106A to 106G, a plurality of storage cavities 108A to 108E and/or a plurality of reaction cavities 109, which can preferably be loaded separately from one another, in particular a first reaction cavity 109A, a second reaction cavity 109B and an optional third reaction cavity 109C, as can be seen in FIG. 2.

The metering cavities 105 are preferably designed to receive, to temporarily store and/or to meter the sample, and/or to pass on said sample in a metered manner Particularly preferably, the metering cavities 105 have a diameter which is larger than that of the (adjacent) channels.

In the initial state of the cartridge or when at the factory, the storage cavities 108 are preferably filled at least in part, in particular with a liquid such as a reagent, solvent or wash buffer.

The collection cavity 111 is preferably designed to receive larger quantities of fluids that are in particular used for the test, such as sample residues or the like. Preferably, in the initial state or when at the factory, the collection cavity 111 is empty or filled with gas, in particular air. The volume of the collection cavity 111 corresponds to or exceeds preferably the (cumulative) volume of the storage cavity/cavities 108 or the liquid content thereof and/or the volume of the receiving cavity 104 or the sample P received.

The reaction cavity/cavities 109 is/are preferably designed to allow a substance located in the reaction cavity 109 to react when an assay is being carried out, for example by being linked or coupled to apparatuses or modules of the analysis device 200.

The reaction cavity/cavities 109 is/are used in particular to carry out an amplification reaction, in particular PCR, or several, preferably different, amplification reactions, in particular PCRs. It is preferable to carry out several, preferably different, PCRs, i.e. PCRs having different primer combinations or primer pairs, in parallel and/or independently and/or in different reaction cavities 109.

“PCR” stands for polymerase chain reaction and is a molecular-biological method by means of which certain analytes, in particular portions of RNA or RNA sequences or DNA or DNA sequences, of a sample P are amplified, preferably in several cycles, using polymerases or enzymes, in particular in order to then test and/or detect the amplification products or nucleic-acid products. If RNA is intended to be tested and/or amplified, before the PCR is carried out, a cDNA is produced starting from the RNA, in particular using reverse transcriptase. The cDNA is used as a template for the subsequent PCR.

The amplification products, target nucleic-acid sequences and/or other portions of the sample P produced in the one or more reaction cavities 109 can be conducted or fed to the connected sensor arrangement or sensor apparatus 113, in particular by means of the pump apparatus 112.

Substitute Specification Docket No. 740126-344

The sensor arrangement or sensor apparatus 113 is used in particular for detecting, particularly preferably qualitatively and/or quantitatively determining, the analyte or analytes of the sample P, in this case particularly preferably the target nucleic-acid sequences and/or target proteins as the analytes. Alternatively or additionally, however, other values may also be collected or determined.

The cartridge 100, the main body 101 and/or the fluid system 103 preferably comprise a plurality of channels 114 and/or valves 115, as shown in FIG. 2.

By means of the channels 114 and/or valves 115, the cavities 104 to 111, the pump apparatus 112 and/or the sensor arrangement or sensor apparatus 113 can be temporarily and/or permanently fluidically interconnected and/or fluidically separated from one another, as required and/or optionally or selectively, in particular such that they are controlled by the analysis device 200.

The cavities 104 to 111 are preferably each fluidically linked or interconnected by a plurality of channels 114. Particularly preferably, each cavity is linked or connected by at least two associated channels 114, in order to make it possible for fluid to fill, flow through and/or drain from the respective cavities as required.

The fluid transport or the fluid system 103 is preferably not based on capillary forces, or is not exclusively based on said forces, but in particular is essentially based on the effects of gravity and/or pumping forces and/or compressive forces and/or suction forces that arise, which are particularly preferably generated by the pump or pump apparatus 112. In this case, the flows of fluid or the fluid transport and the metering are controlled by accordingly opening and closing the valves 115 and/or by accordingly operating the pump or pump apparatus 112, in particular by means of a pump drive 202 of the analysis device 200.

Preferably, each of the cavities 104 to 110 has an inlet at the top and an outlet at the bottom in the operating position. Therefore, if required, only liquid from the respective cavities can be removed via the outlet.

In the operating position, the liquids from the respective cavities are preferably removed, in particular drawn out, via the outlet that is at the bottom in each case, it preferably being possible for gas or air to flow and/or be pumped into the respective cavities via the inlet that is in particular at the top. In particular, relevant vacuums in the cavities can thus be prevented or at least minimized when conveying the liquids.

In particular, the cavities, particularly preferably the storage cavity/cavities 108, the mixing cavity 107 and/or the receiving cavity 104, are each dimensioned and/or oriented in the normal operating position such that, when said cavities are filled with liquid, bubbles of gas or air that may potentially form rise upwards in the operating position, such that the liquid collects above the outlet without bubbles. However, other solutions are also possible here.

The receiving cavity 104 preferably comprises a connection 104A for introducing the sample P. In particular, the sample P may for example be introduced into the receiving cavity 104 and/or cartridge 100 via the connection 104A by means of a pipette, syringe or other instrument.

The receiving cavity 104 preferably comprises an inlet 104B, an outlet 104C and an optional intermediate connection 104D, it preferably being possible for the sample P or a portion thereof to be removed and/or conveyed further via the outlet 104C and/or the optional intermediate connection 104D. Gas, air or another fluid can flow in and/or be pumped in via the inlet 104B, as already explained.

Preferably, the sample P or a portion thereof can be removed, optionally and/or depending on the assay to be carried out, via the outlet 104C or the optional intermediate connection 104D of the receiving cavity 104. In particular, a supernatant of the sample P, such as blood plasma or blood serum, can be conducted away or removed via the optional intermediate connection 104D, in particular for carrying out the protein assay.

Preferably, at least one valve 115 is assigned to each cavity, the pump apparatus 112 and/or the sensor apparatus 113 and/or is arranged upstream of the respective inlets and/or downstream of the respective outlets.

Preferably, the cavities 104 to 111 or sequences of cavities 104 to 111, through which fluid flows in series or in succession for example, can be selectively released and/or fluid can selectively flow therethrough by the assigned valves 115 being actuated, and/or said cavities can be fluidically connected to the fluid system 103 and/or to other cavities.

In particular, the valves 115 are formed by the main body 101 and the film or cover 102 and/or are formed therewith and/or are formed in another manner, for example by or having additional layers, depressions or the like.

Particularly preferably, one or more valves 115A are provided which are preferably tightly closed initially or in the storage state, particularly preferably in order to seal liquids or liquid reagents F, located in the storage cavities 108, and/or the fluid system 103 from the open receiving cavity 104 in a storage-stable manner.

Preferably, an initially closed valve 115A is arranged upstream and downstream of each storage cavity 108. Said valves are preferably only opened, in particular automatically, when the cartridge 100 is actually being used and/or during or after inserting the cartridge 100 into the analysis device 200 and/or for carrying out the assay.

A plurality of valves 115A, in particular three valves in this case, are preferably assigned to the receiving cavity 104, in particular if the intermediate connection 104D is provided in addition to the inlet 104B and the outlet 104C. Depending on the use, in addition to the valve 115A on the inlet 104B, then preferably only the valve 115A either at the outlet 104C or at the intermediate connection 104D is opened.

The valves 115A assigned to the receiving cavity 104 seal the fluid system 103 and/or the cartridge 100 in particular fluidically and/or in a gas-tight manner, preferably until the sample P is introduced and/or the receiving cavity 104 or the connection 104A of the receiving cavity 104 is closed.

As an alternative or in addition to the valves 115A (which are initially closed), one or more valves 115B are preferably provided which are not closed in a storage-stable manner and/or which are open initially or in an inoperative position, in an initial state or when the cartridge 100 is not inserted into the analysis device 200, and/or which can be closed by actuation. These valves 115B are used in particular to control the flows of fluid during the test.

The cartridge 100 is preferably designed as a microfluidic card and/or the fluid system 103 is preferably designed as a microfluidic system. In the present invention, the term “microfluidic” is preferably understood to mean that the respective volumes of individual cavities, some of the cavities or all of the cavities 104 to 111 and/or channels 114 are, separately or cumulatively, less than 5 ml or 2 ml, particularly preferably less than 1 ml or 800 μl, in particular less than 600 μl or 300 μl, more particularly preferably less than 200 μl or 100 μl.

Particularly preferably, a sample P having a maximum volume of 5 ml, 2 ml or 1 ml can be introduced into the cartridge 100 and/or the fluid system 103, in particular the receiving cavity 104.

Reagents and liquids which are preferably introduced or provided before the test in liquid form as liquids or liquid reagents F and/or in dry form as dry reagents S are required for testing the sample P, as shown in the schematic view according to FIG. 2 by reference signs F1 to F5 and S1 to S10.

Furthermore, other liquids F, in particular in the form of a wash buffer, solvent for dry reagents S and/or a substrate, for example in order to form detection molecules D and/or a redox system, are also preferably required for the test, the detection process and/or for other purposes, and are in particular provided in the cartridge 100, i.e. are likewise introduced before use, in particular before delivery or in the delivery state. At some points in the following, a distinction is not made between liquid reagents and other liquids, and therefore the respective explanations are accordingly also mutually applicable. In particular, in the following reference is generally made to liquid reagent F. This preferably also includes all other liquids provided.

The cartridge 100 preferably contains all the reagents and liquids required for pretreating the sample P and/or for carrying out the test or assay, in particular for carrying out one or more amplification reactions or PCRs, and therefore, particularly preferably, it is only necessary to receive the optionally pretreated sample P.

The cartridge 100 or the fluid system 103 preferably comprises a bypass 114A that can optionally be used, in order for it to be possible, if necessary, to conduct or convey the sample P or components thereof past the reaction cavities 109 and/or, by bypassing the optional intermediate temperature-control cavity 110, also directly to the sensor apparatus 113.

The cartridge 100, the fluid system 103 and/or the channels 114 preferably comprise sensor portions 116 or other apparatuses for detecting liquid fronts and/or flows of fluid.

It is noted that various components, such as the channels 114, the valves 115, in particular the valves 115A that are initially closed and the valves 115B that are initially open, and the sensor portions 116 in FIG. 2 are, for reasons of clarity, only labelled in some cases, but the same symbols are used in FIG. 2 for each of these components.

The collection cavity 111 is preferably used for receiving excess or used reagents and liquids and volumes of the sample, and/or for providing gas or air in order to empty individual cavities and/or channels. In the initial state, the collection cavity 111 is preferably filled solely with gas, in particular air.

In particular, the collection cavity 111 can optionally be fluidically connected to individual cavities and channels 114 or to other apparatuses, in order to remove reagents and liquids from said cavities, channels or other apparatuses and/or to replace said reagents and liquids with gas or air. The collection cavity 111 is preferably given appropriate large dimensions.

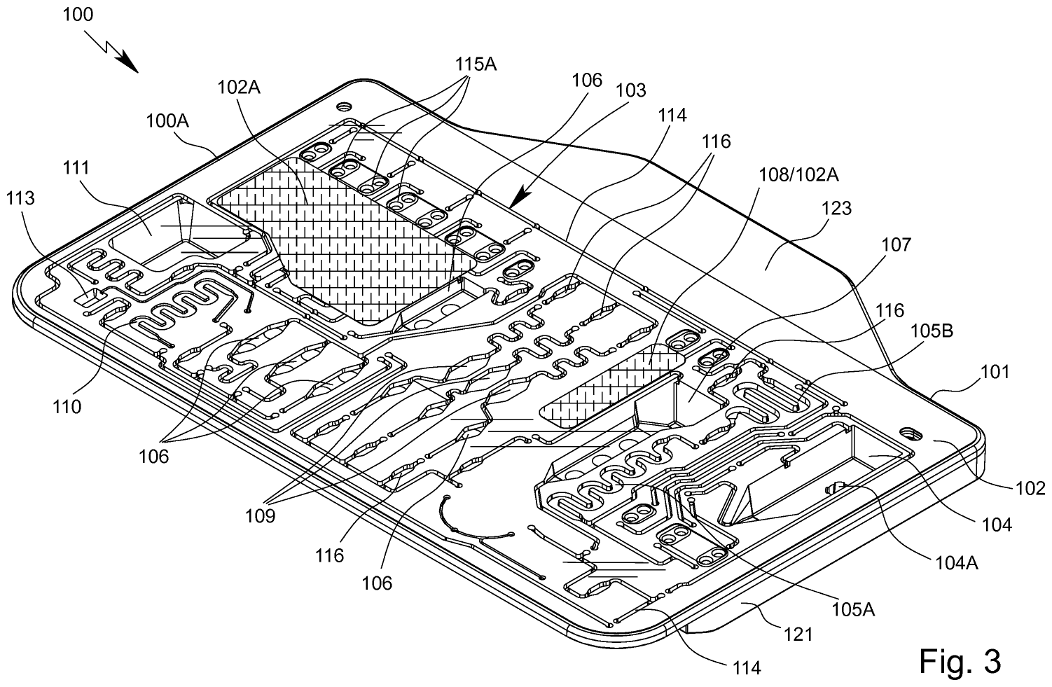

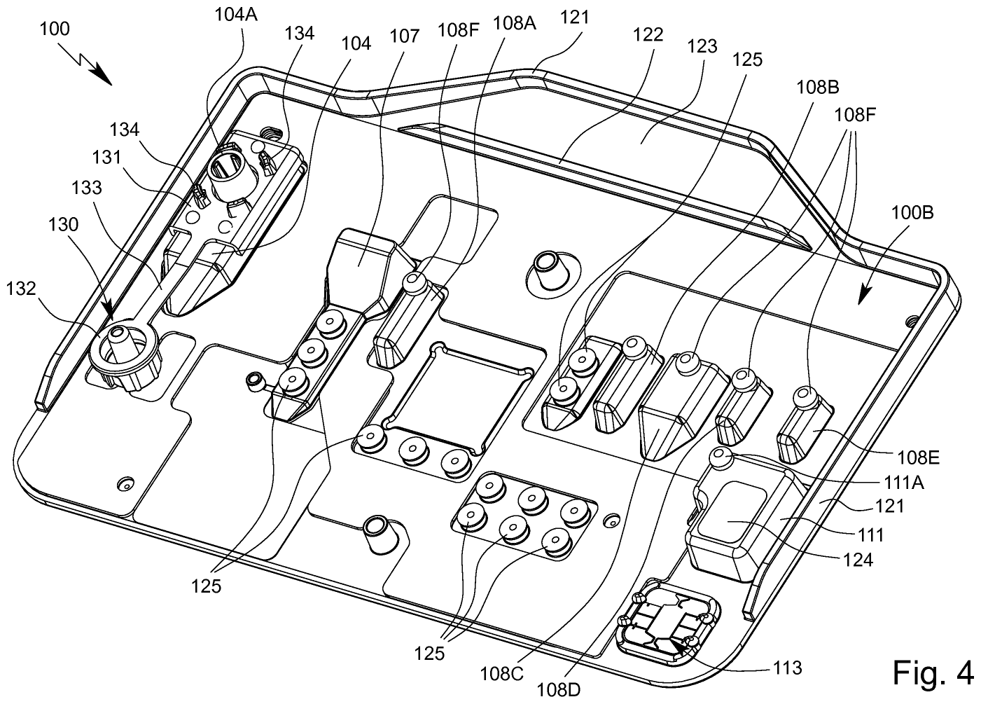

FIG. 3 is a perspective front view of the cartridge 100, i.e. of the front 100A thereof, and FIG. 4 is a perspective rear view of the cartridge 100, i.e. of the back 100B thereof.

The cartridge 100 or the main body 101 preferably comprises a reinforced or angled edge 121 and/or a reinforcing rib 122, particularly preferably on the back 100B, as shown schematically in FIG. 4.

The cartridge 100 or the main body 101 preferably comprises a grip portion 123 in order for it to be possible to optimally grip and/or hold the cartridge 100 by hand.

The cartridge 100 preferably comprises an in particular optically readable identifier, such as a barcode 124.

The connection 104A of the receiving cavity 104 can be closed after the sample P has been received. The cartridge 100 preferably comprises a closure element 130 for this purpose.

In particular, the connection 104A can be closed in a liquid-tight and particularly preferably also gas-tight manner by the closure element 130. In particular, a closed fluid circuit can thus be formed, with the receiving cavity 104 being included. In particular, the receiving cavity 104 thus forms part of the fluid system 103 of the cartridge 100, wherein the fluid system is preferably closed or can be closed by the closure element 130.

The closure element 130 closes the receiving cavity 104 or the connection 104A thereof preferably in a permanent manner, i.e. it preferably cannot be released again. The connection 104A therefore preferably cannot be reopened after it has been closed.

In the example shown, the closure element 130 preferably comprises a base part 131 and a closure part 132, the closure part 132 being movably and/or pivotally connected to the base part 131 in particular by means of a connecting part 133 that is preferably formed bar-like in this case.

Preferably, in the closed state, the closure element 130 or the closure part 132 thereof is held on the connection 104A in a latching or form-fit or interlocking manner, in this case in particular by means of one or more latching or retaining arms or elements 134, as shown in FIG. 3. However, other structural solutions are also possible.

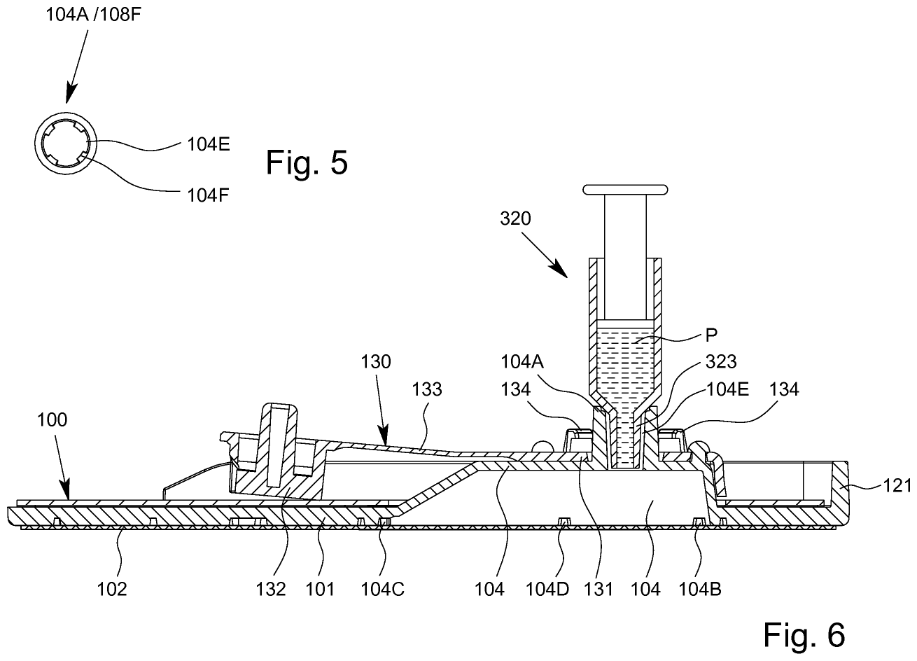

FIG. 5 is a schematic plan view of the connection 104A of the receiving cavity 104 or of an opening 108F in a storage cavity 108 for filling said storage cavity 108 with a liquid reagent F, preferably before delivery.

Preferably, the connection 104A, which is in particular substantially designed as a so-called Luer connection or Luer port or as a conical receiving opening, comprises an integrated vent 104E which is in particular formed by corresponding axial grooves in the inner wall of the connection 104 and/or by axially extending ridges and/or by inwardly protruding projections 104F, as shown in FIG. 5.

FIG. 6 is a highly schematic sectional detail of the cartridge 100 or the receiving cavity 104 being filled, by means of a transfer apparatus 320, with the sample P to be tested. The transfer apparatus 320 is preferably formed in the manner of a syringe. However, other structural solutions are also possible.

The transfer apparatus 320 is preferably connected to and/or plugged into the connection 104A by means of a connection 323, in particular a connecting tip, particularly preferably in such a way that the vent 104E or the grooves formed thereby remain open so that, when the receiving cavity 104 is filled (in part) with the sample P, gas or air can escape from the receiving cavity 104 to the outside through the vent 104E. In this regard it is noted that, in the delivery state, the valves 115A assigned to the receiving cavity 104 are all closed, and the fluid system 103 is thus closed off from the receiving cavity 104 such that displaced air can escape only through the connection 104A and/or the vent 104E that is particularly preferably provided. However, other structural solutions are in principle also possible.

FIG. 6 shows the cartridge 100 together with the connected transfer apparatus 320, but before the receiving cavity 104 is actually filled with the sample P or before said sample is actually fed to said cavity.

Preferably, when producing the cartridge 100, the cover 102 is first connected to the main body 101, and the cavities 104-111 are thus covered by the cover 102. Further, the corresponding valves 115, in particular also the initially closed valves 115A, are formed or produced.

Preferably only after this are one or more liquid reagents F, in particular all the liquid reagents F, introduced into the respective storage cavities 108. This is carried out in particular through the main body 101 and/or the base of the respective storage cavities 108. In particular, the main body 101 and/or the respective storage cavities 108 comprise a corresponding opening 108F (as shown in FIG. 4 and FIG. 5), through which the respective storage cavities 108 are filled with the associated liquid reagent F.

The cartridge 100 is therefore preferably filled with liquid reagents F from the back or from the (flat) side of the cartridge 100 opposite the cover 102, and/or through the main body 101.

The openings 108F are preferably arranged on the back 100B and/or base/bottom of the respective storage cavity 108.

Preferably, the openings 108F protrude from the main body 101 of the cartridge 100, in particular transversely or perpendicularly to the main plane of the body 101 or cartridge 100.

The openings 108F are preferably formed by at least essentially cylindrical or conical walls or sections, in particular of the main body 101, and/or similar to the connection 104A of the receiving cavity 104 which is shown in FIG. 6.

Within the meaning of the present invention, the term “opening” denotes a wall or a section of the main body 101, which preferably protrudes from the main body. In particular, an opening is not the “hole” itself, but the section surrounding or defining the hole. Therefore, an opening can be closed. In particular, a closed opening is still visible and/or or can still be identified on the cartridge 100. Particularly preferably, an opening is still physically present even when it has been closed, welded or heat-sealed.

In order to facilitate the filling process, the openings 108F preferably each comprise an integrated vent 104E that corresponds to the integrated vent 104E of the connection 104A of the receiving cavity 104. Accordingly, during the filling process, the gas, in particular air, contained in the respective storage cavities 108 can in each case escape directly through the opening 108F or integrated vent 104E, since the respective storage cavities 108 are otherwise already closed.

Following the filling process, the storage cavities 108 or the openings 108F therein are closed, in particular in a gas-tight manner. The openings 108F are in particular closed and/or welded or heat-sealed in an irreversible manner.

The openings 108F are shown only in the closed state in FIG. 4. The corresponding integrated vents 104E are therefore not visible, but are preferably designed in a manner corresponding to the optional vent 104E of the connection 104A, as illustrated in FIG. 5 which shows an opening 108F in the open state.

It is noted that, during the above-mentioned filling process, the respective storage cavities 108 are otherwise preferably closed fluidically and in particular in a gas-tight manner, preferably by means of two associated, initially closed valves 115A, such that the respective liquid reagents F cannot flow into other channels 114 or into the following fluid system 103, which is separated therefrom initially or in the delivery state, while said reagents are being introduced or filled in.

The dry reagents S are particularly preferably introduced into the respective cavities 106, 107 and 109 by means of carrier elements 125 (as shown schematically in FIG. 4). In particular, the carrier elements 125 carry the respective dry reagents S and are (sealingly) inserted into the main body 101 and/or the base of the respective cavities 106, 107, 109, particularly preferably welded or heat-sealed therein, as described in particular in International Publication No WO 2015/001070 A1.

The dry reagents S can be introduced as desired before or after the storage cavities 108 are filled with liquid reagents F.

During production of the cartridge 100, the fluid system 103 is initially formed so as to be separated from the storage cavities 108 and the receiving cavity 104, in particular by means of the initially closed valves 115A, and said system or cartridge is also delivered in this state. This separated part of the fluid system 103, also referred to simply as fluid system 103 for short, comprises a plurality of channels 114 and cavities 105-107 and 109-111 which are in particular fluidically linked. Accordingly, different, or in this case even all, dry reagents S are exposed to the same atmosphere.

Preferably, a pre-conditioned atmosphere, in particular the same atmosphere, is provided or specified in the fluid system 103 and/or in the cartridge 100 for different or all dry reagents S, in the sense mentioned at the outset.

The sensor apparatus 113, which is preferably designed for electrochemically detecting and/or for chemically bonding at least one analyte of the sample P, is preferably likewise connected to the fluid system 103 in the delivery state, and therefore the conditioned atmosphere is likewise also applied to said sensor apparatus 113.

Accordingly, as a result of the conditioned atmosphere, particularly good storage stability can be achieved for both the dry reagents S and the sensor apparatus 113.

The conditioned atmosphere is brought or introduced into the cartridge 100 and/or the fluid system 103 in particular through the main body 101 and/or the base of a cavity, in particular through an opening 111A in the collection cavity 111. The opening 111A is subsequently closed in a gas-tight and/or irreversible manner, in particular welded or heat-sealed. This state is shown in FIG. 4.

The conditioned atmosphere is introduced into the otherwise already closed fluid system 103, in particular through just one single opening 111A. This results in very simple production.

Particularly preferably, the fluid system 103 and/or the cartridge 100 is first evacuated before the conditioned atmosphere is introduced. This can be achieved in a very simple manner by applying negative pressure to or evacuating the cartridge 100 as a whole, such that air or another gas composition contained in the fluid system 103 first escapes through the open opening 111A (in particular only through this opening 111A, since the fluid system 103 is otherwise closed in this state). Subsequently, the desired conditioned atmosphere is introduced into the fluid system 103, in particular again by exposing the cartridge 100 to the desired atmosphere.

Preferably, the conditioned atmosphere is an atmosphere that is conditioned or defined with regard to its, in particular physical and/or chemical, composition, the relative atmospheric humidity and/or the pressure.

In particular, the conditioned atmosphere comprises a defined, in particular physical and/or chemical, composition, humidity and/or pressure.

Particularly preferably, the conditioned atmosphere has a pressure that at least substantially corresponds to normal pressure or is higher than normal pressure, preferably by at least 5 or 10%.

Particularly preferably, the conditioned atmosphere comprises a gas or gas composition, for example an inert gas or gas mixture, which is conducive to high storage stability of the dry reagent(s) S and/or of the sensor apparatus 113.

Particularly preferably, the conditioned atmosphere is formed by dried air and/or has a relative atmospheric humidity that is conducive to long storage stability of the dry reagent(s) S and/or of the sensor apparatus 113. The relative atmospheric humidity of the conditioned atmosphere is preferably less than 40%, more preferably less than 25%, in particular less than 10%.

In order to achieve particularly good storage stability of the liquid reagent(s) F, the cover 102 is preferably produced from or reinforced by an inorganic material, in particular metal, particularly preferably aluminium, preferably in the region of at least one storage cavity 108. This is preferably achieved by applying or adhesively bonding a piece of material or film sheet, consisting of or produced from the corresponding material, as an additional cover 102A in the region of the respective storage cavities 108, as shown schematically in FIG. 3. This allows for very simple production, since the (substantially) continuous film can first be applied as a cover 102 and the additional cover 102A (consisting at least in part of inorganic material or metal) only then is applied or adhesively bonded, in the desired region, to the film or to the cover 102 located below the additional cover 102A.

Once the sample P has been introduced into the receiving cavity 104 and the connection 104A has been closed, the cartridge 100 can be inserted into and/or received in the proposed analysis device 200, as shown in FIG. 1, in order to test the sample P.

The analysis device 200 preferably comprises a mount or receptacle 201 for mounting and/or receiving the cartridge 100.

Preferably, the cartridge 100 is fluidically, in particular hydraulically, separated or isolated from the analysis device 200. In particular, the cartridge 100 forms a preferably independent and in particular closed or sealed fluidic or hydraulic system 103 for the sample P and the reagents and other liquids. In this way, the analysis device 200 does not come into direct contact with the sample P and can in particular be reused for another test without being disinfected and/or cleaned first.

It is however provided that the analysis device 200 is connected or coupled mechanically, electrically, thermally and/or pneumatically to the cartridge 100.

In particular, the analysis device 200 is designed to have a mechanical effect, in particular for actuating the pump apparatus 112 and/or the valves 115, and/or to have a thermal effect, in particular for temperature-controlling the reaction cavity/cavities 109 and/or the intermediate temperature-control cavity 110.

In addition, the analysis device 200 can preferably be pneumatically connected to the cartridge 100, in particular in order to actuate individual apparatuses, and/or can be electrically connected to the cartridge 100, in particular in order to collect and/or transmit measured values, for example from the sensor apparatus 113 and/or sensor portions 116.

The analysis device 200 preferably comprises a pump drive 202, the pump drive 202 in particular being designed for mechanically actuating the pump apparatus 112.

The analysis device 200 preferably comprises a connection apparatus 203 for in particular electrically and/or thermally connecting the cartridge 100 and/or the sensor arrangement or sensor apparatus 113.

As shown in FIG. 1, the connection apparatus 203 preferably comprises a plurality of electrical contact elements 203A, the cartridge 100, in particular the sensor arrangement or sensor apparatus 113, preferably being electrically connected or connectable to the analysis device 200 by the contact elements 203A.

The analysis device 200 preferably comprises one or more temperature-control apparatuses 204 for temperature-controlling the cartridge 100 and/or having a thermal effect on the cartridge 100, in particular for heating and/or cooling, the temperature-control apparatus(es) 204 (each) preferably comprising or being formed by a heating resistor or a Peltier element.

Preferably, individual temperature-control apparatuses 204, some of these apparatuses or all of these apparatuses can be positioned against the cartridge 100, the main body 101, the cover 102, the sensor arrangement, sensor apparatus 113 and/or individual cavities and/or can be thermally coupled thereto and/or can be integrated therein and/or can be operated or controlled in particular electrically by the analysis device 200. In the example shown, in particular the temperature-control apparatuses 204A, 204B and/or 204C are provided.

The analysis device 200 preferably comprises one or more actuators 205 for actuating the valves 115. Particularly preferably, different (types or groups of) actuators 205A and 205B are provided which are assigned to the different (types or groups of) valves 115A and 115B for actuating each of said valves, respectively.

The analysis device 200 preferably comprises one or more sensors 206. In particular, sensors 206A are assigned to the sensor portions 116 and/or are designed or intended to detect liquid fronts and/or flows of fluid in the fluid system 103.

Particularly preferably, the sensors 206A are designed to measure or detect, in particular in a contact-free manner, for example optically and/or capacitively, a liquid front, flow of fluid and/or the presence, the speed, the mass flow rate/volume flow rate, the temperature and/or another value of a fluid in a channel and/or a cavity, in particular in a respectively assigned sensor portion 116, which is in particular formed by a planar and/or widened channel portion of the fluid system 103.

Alternatively or additionally, the analysis device 200 preferably comprises (other or additional) sensors 206B for detecting the ambient temperature, internal temperature, atmospheric humidity, position, and/or alignment, for example by means of a GPS sensor, and/or the orientation and/or inclination of the analysis device 200 and/or the cartridge 100.

The analysis device 200 preferably comprises a control apparatus 207, in particular comprising an internal clock or time base for controlling the sequence of a test or assay and/or for collecting, evaluating and/or outputting or providing measured values in particular from the sensor apparatus 113, and/or from test results and/or other data or values.

The control apparatus 207 preferably controls or feedback controls the pump drive 202, the temperature-control apparatuses 204 and/or actuators 205, in particular taking into account or depending on the desired test and/or measured values from the sensor arrangement or sensor apparatus 113 and/or sensors 206.

Optionally, the analysis device 200 comprises an input apparatus 208, such as a keyboard, a touch screen or the like, and/or a display apparatus 209, such as a screen.

The analysis device 200 preferably comprises at least one interface 210, for example for controlling, for communicating and/or for outputting measured data or test results and/or for linking to other devices, such as a printer, an external power supply or the like. This may in particular be a wired or wireless interface 210.

The analysis device 200 preferably comprises a power supply 211 for providing electrical power, preferably a battery or an accumulator, which is in particular integrated and/or externally connected or connectable.

Preferably, an integrated accumulator is provided as a power supply 211 and is (re)charged by an external charging device (not shown) via a connection 211A and/or is interchangeable.

The analysis device 200 preferably comprises a housing 212, all the components and/or some or all of the apparatuses preferably being integrated in the housing 212. Particularly preferably, the cartridge 100 can be inserted or slid into the housing 212, and/or can be received by the analysis device 200, through an opening 213 which can in particular be closed, such as a slot or the like.

The analysis device 200 is preferably portable or mobile. Particularly preferably, the analysis device 200 weighs less than 25 kg or 20 kg, particularly preferably less than 15 kg or 10 kg, in particular less than 9 kg or 6 kg.

As already explained, the analysis device 200 can preferably be pneumatically linked to the cartridge 100, in particular to the sensor arrangement or sensor apparatus 113 and/or to the pump apparatus 112.

Particularly preferably, the analysis device 200 is designed to supply the cartridge 100, in particular the sensor arrangement or sensor apparatus 113 and/or the pump apparatus 112, with a working medium, in particular gas or air.

Preferably, the working medium can be compressed and/or pressurised in the analysis device 200 or by means of the analysis device 200.

Preferably, the analysis device 200 comprises a pressurised gas supply 214, in particular a pressure generator or compressor, preferably in order to compress, condense and/or pressurise the working medium.

The pressurised gas supply 214 is preferably integrated in the analysis device 200 or the housing 212 and/or can be controlled or feedback controlled by means of the control apparatus 207.

Preferably, the pressurised gas supply 214 is electrically operated or can be operated by electrical power. In particular, the pressurised gas supply 214 can be supplied with electrical power by means of the power supply 211.

Preferably, air can be drawn in, in particular from the surroundings, as the working medium by means of the analysis device 200 or pressurised gas supply 214. In particular, the analysis device 200 or pressurised gas supply 214 is designed to use the surroundings as a reservoir for the working medium or the air. However, other solutions are also possible here, in particular those in which the analysis device 200 or pressurised gas supply 214 comprises a preferably closed or delimited reservoir, such as a tank or container, comprising the working medium, and/or is connected or connectable thereto.

The analysis device 200 or pressurised gas supply 214 preferably comprises a connection element 214A, in particular in order to pneumatically connect the analysis device 200 or pressurised gas supply 214 to the cartridge 100.

In particular, the present invention relates also to any one of the following aspects which can be realized independently or in any combination, also in combination with any aspects described above or in the claims:

1. Cartridge 100 for testing an in particular biological sample P, the cartridge 100 comprising a main body 101 having a plurality of channels 114 and cavities 104-111, and comprising a cover 102 for the channels 114 and cavities 104-111, characterized in that the cartridge 100 comprises one or more storage cavities 108 which are each individually fluidically closed by the cover 102 and/or valves 115A of the cartridge 100 in the delivery state, and into each of which cavities a liquid reagent F is introduced through a corresponding opening 108F in the main body 121, the opening 108F likewise being closed in the delivery state, in that a plurality of channels 114 and cavities 105-107, 109-111 form a fluid system 103 that is fluidically closed to the outside in the delivery state of the cartridge 100, and a conditioned atmosphere is introduced into the fluid system 103 through the main body 101.
2. Method for producing a cartridge 100 for testing an in particular biological sample P, a cover 102 being sealingly applied to the front of a main body 101 comprising a plurality of channels 114 and cavities 104-111 in order to close the channels 114 and cavities 104-111 in the delivery state, characterized in that an otherwise already closed storage cavity 108 is filled with liquid reagent F from the back through an opening 108F in the main body 101, and the opening 108F is subsequently closed, and/or in that a fluid system 103 that is fluidically closed to the outside in the delivery state is formed by a plurality of channels 114 and cavities 105-107, 109-111, the fluid system containing one or more dry reagents S and/or a sensor apparatus 113 for chemically bonding at least one analyte of the sample P, a conditioned atmosphere in particular being introduced into the fluid system 103 from the back through the main body 101. Individual aspects and features of the present invention and individual method steps and/or method variants may be implemented independently from one another, but also in any desired combination and/or order.

1-22. (canceled)

23. A cartridge for testing a sample, comprising:
a main body having a plurality of channels and cavities; and
a cover for the channels and cavities,
wherein the cartridge further includes at least one of the following features:
the cartridge comprises one or more storage cavities which are each individually fluidically closed by the cover and/or valves of the cartridge, each of which storage cavities contains a liquid reagent and comprises a corresponding opening in the main body for introducing the respective reagent, the openings being closed after introducing the respective reagents; and
the plurality of channels and cavities form a fluid system that is fluidically closed to the outside in a delivery state of the cartridge, wherein a conditioned atmosphere is introduced into the fluid system through the main body, the conditioned atmosphere being conditioned with regard to at least one of composition, humidity, and pressure.

24. The cartridge according to claim 23, wherein the opening is arranged in the base of the respective storage cavities.

25. The cartridge according to claim 23, wherein the opening is arranged on the side of the cartridge or main body remote from the cover.

26. The cartridge according to claim 23, wherein the opening is closed in a gas-tight manner, by welding or heat-sealing.

27. The cartridge according to claim 23, wherein the opening is closed in an irreversible manner.

28. The cartridge according to claim 23, wherein the opening comprises an integrated vent for venting the storage cavity when the liquid reagent is received.

29. The cartridge according to claim 23, wherein the cover closes a plurality or all of the channels and cavities on a front or a flat side of the cartridge.

30. The cartridge according to claim 23, wherein the cover is produced from or additionally covered by an inorganic material, at least in part in the region of the one or more storage cavities.

31. The cartridge according to claim 23, wherein in the delivery state, the fluid system contains one or more dry reagents that are exposed to the conditioned atmosphere.

32. The cartridge according to claim 23, wherein in the delivery state, the cartridge contains all of the reagents required for testing the sample.

33. The cartridge according to claim 32, wherein the reagents include at least one of a buffer and a solvent.

34. The cartridge according to claim 23, wherein the cartridge further comprises a sensor apparatus for electrochemically detecting or for chemically bonding an analyte of the sample, the sensor apparatus being fluidically connected to the fluid system in the delivery state and being exposed to the conditioned atmosphere.

35. The cartridge according to claim 23, wherein the cartridge further comprises a receiving cavity for receiving the sample, and wherein, in the delivery state, the receiving cavity is fluidically separated from the fluid system.

36. The cartridge according to claim 35, wherein the receiving cavity is fluidically separated from the fluid system by openable valves.

37. A method for producing a cartridge for testing a sample, comprising:
applying a cover to a front of a main body of the cartridge, which main body is comprised of a plurality of channels and cavities, to close the channels and cavities in a delivery state; and
the method further including at least one of the following steps:
filling an otherwise already closed cavity with liquid reagent through an opening in a back of the main body, and subsequently closing the opening; and
forming a fluid system that is fluidically closed to the outside in the delivery state by the plurality of channels and cavities, the fluid system containing one or more dry reagents or a sensor apparatus for chemically bonding at least one analyte of the sample, a conditioned atmosphere being introduced into the fluid system from the back through the main body, the conditioned atmosphere being conditioned with regard to at least one of composition, humidity and/or pressure.

38. The method according to claim 37, wherein the main body is produced or injection-moulded from plastics material.

39. The method according to claim 37, wherein the main body is produced so as to have the opening.

40. The method according to claim 37, wherein the opening is closed in a gas-tight or irreversible manner, by welding or heat-sealing, after the liquid reagent has been received.

41. The method according to claim 37, wherein the otherwise closed fluid system is first evacuated through an opening in the base of a cavity, and the conditioned atmosphere is subsequently introduced through the opening in the base and the opening in the base is closed in a gas-tight manner on a fluid side.

42. The method according to claim 37, wherein the cover is additionally covered or adhered over with an additional cover made of an inorganic material in a region of at least one storage cavity in order to cover or close the storage cavity in a diffusion-resistant manner.
